(19) United States
(12) Patent Application Publication
(10) Pub. No.: US 2026/0292585 A1
(43) Pub. Date: Sep. 24, 2026

(54) PROTOCOL DATA UNIT SET BASED QUALITY OF SERVICE HANDLING IN A DISTRIBUTED BASE STATION

(71) Applicant: GOOGLE LLC, Mountain View, CA (US)

(72) Inventor: Chih-Hsiang Wu, Taoyuan City (TW)

(21) Appl. No.: 19/477,464

(22) PCT Filed: Apr. 21, 2024
(86) PCT No.: PCT/US2024/025619

§ 371 Date: Oct. 21, 2025

Related U.S. Application Data
(60) Provisional application No. 63/497,704, filed on Apr. 21, 2023.

(51) Int. Cl. H04W 28/02; H04L 67/131

(52) U.S. Cl. CPC H04W 28/0268; H04L 67/131

(57) ABSTRACT

A centralized unit (CU) of a distributed base station that also includes a distributed unit (DU) transmits (413), to the DU, a request related to a context of a UE that communicates with a core network (CN) via the DU and the CU, the request including a packet data unit (PDU) Set quality of service (QoS) parameter for a QoS flow; receives (414), from the DU, a response to the request; and communicates (426), between the CN and the UE via the DU, a data packet in the QoS flow.

### CROSS-REFERENCE TO RELATED APPLICATION

This application claims priority to and the benefit of the filing date of provisional U.S. Patent Application No. 63/497,704 entitled “Enabling Protocol Data Unit Set Based Quality of Service Handling in a Distributed Base Station,” filed on Apr. 21, 2023. The entire content of the provisional application is hereby expressly incorporated herein by reference.

### FIELD OF THE DISCLOSURE

This disclosure relates to wireless communications and, more particularly, to enabling setup or modification of radio resources for high-data-rate and low latency services such as extended Reality (XR) services and cloud gaming.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer.

The Packet Data Convergence Protocol (PDCP) sublayer provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

PDUs in some cases carry eXtended Reality (XR) traffic such as Augmented Reality (AR) traffic for overlaying virtual elements on imagery of the real environment, Virtual Reality (VR) traffic for providing imagery, sounds, etc. in a purely virtual environment, and/or Mixed Reality (MR) traffic for the environment in which real and virtual elements interact in real time. As another example, PDUs can carry cloud gaming traffic.

XR services and cloud gaming generally require high-data-rate and low-latency transmissions. The Third Generation Partnership Project (3GPP) recently defined new quality of service (QoS) requirements to support XR services and cloud gaming. However, it is not clear how a RAN should support the new quality of service requirements for protocol data unit (PDU) Sets (which include one or more PDUs carrying a payload of one unit of information generated at the application level) in a disaggregated base station that includes a centralized unit (CU) and a distributed unit (DU).

### SUMMARY

An example embodiment of these techniques is a method implemented in a centralized unit (CU) of a distributed base station that also includes a distributed unit (DU). The method includes transmitting, to the DU, a request related to a context of a UE that communicates with a core network (CN) via the DU and the CU, the request including a packet data unit (PDU) Set quality of service (QoS) parameter for a QoS flow; receiving, from the DU, a response to the request; and communicating, between the CN and the UE via the DU, a data packet in the QoS flow.

Another example embodiment of these techniques is a method implemented in a distributed unit (DU) of a distributed base station that also includes a centralized unit (CU). The method includes receiving, from the CU, a request related to a context of a UE that communicates with a core network (CN) via the DU and the CU, the request including a packet data unit (PDU) Set quality of service (QoS) parameter for a QoS flow; transmitting, from the CU, a response to the request; and communicating, between the CN and the UE via the CU, a data packet in the QoS flow in accordance with the PDU Set QoS parameter.

Yet another example embodiment of these techniques is a radio access network (RAN) node including processing hardware and configured to implement one of the methods above.

### BRIEF DESCRIPTION OF THE DRAWINGS

FIG. 1A is a block diagram of an example wireless communication system in which a base station can implement the techniques of this disclosure to support PDU Set handling;

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a message sequence diagram of an example scenario in which a core network (CN) transmits PDU Set quality of service (QoS) parameters to a CU, which in turn transmits the PDU Set QoS parameters to a DU for PDU-Set-based QoS handing of certain traffic;

FIG. 4A is a flow diagram of an example method for configuring a DU with PDU Set QoS parameters, to support PDU-Set-based handling of traffic, which can be implemented in a CU of a distributed base station;

FIG. 4B is a flow diagram of another example method for configuring a DU with PDU Set QoS parameters, based on whether the DU supports the PDU-Set-based handling of traffic;

FIG. 5A is a flow diagram of an example method for determining whether to configure a DU with PDU Set QoS parameters based on the configuration the CN provided, which can be implemented in a CU of a distributed base station;

FIG. 5B is a flow diagram of an example method generally similar to that of FIG. 5A, but with an additional determination of whether the CU and DU support PDU-Set-based handling of traffic;

FIG. 6A is a flow diagram of an example method for communicating data using PDU Set information in accordance with a PDU Set QoS parameters received from the CU, which can be implemented in a DU of a distributed base station;

FIG. 6B is a flow diagram of another example method for communicating data using PDU Set information, based on whether the CU provided the DU with PDU Set QoS parameters for the UE;

FIG. 6C is a flow diagram of another example method for communicating data using PDU Set information, based on whether the UE supports PDU-Set-based handling of traffic;

FIG. 7A is a flow diagram of a method for determining whether to enable PDU-Set-based QoS handling for data for a UE, based on whether the CU provided PDU Set QoS parameters for the UE, which can be implemented in a DU of a distributed base station;

FIG. 7B is a flow diagram of an example method generally similar to that of FIG. 7A, but with an additional determination of whether the DU supports PDU-Set-based handling of traffic;

FIG. 8A is a flow diagram of a method for determining whether to configure a UE with a PDU Set QoS parameter, based on whether the CU provided PDU Set QoS parameters for the UE, which can be implemented in a DU of a distributed base station;

FIG. 8B is a flow diagram of an example method generally similar to that of FIG. 8A, but with an additional determination of whether the DU and/or the UE supports PDU-Set-based handling of traffic;

FIG. 8C is a flow diagram of another example method generally similar to that of FIG. 8A, but in which the DU selects a value of a configuration parameter based on whether the CU provided PDU Set QoS parameters for the UE;

FIG. 8D is a flow diagram of another example method generally similar to that of FIG. 8B, but in which the DU selects a value of a configuration parameter based on whether the CU provided PDU Set QoS parameters for the UE, and whether the UE and/or the DU supports PDU-Set-based handling of traffic;

FIG. 9A is a flow diagram of an example method for configuring a DU with a parameter for an XR service, which can be implemented in a CU of a distributed base station;

FIG. 9B is a flow diagram of an example method for configuring a DU with a parameter for an XR service, based on whether the UE supports certain functionality related to XR, which can be implemented in a CU of a distributed base station;

FIG. 10A is a flow diagram of an example method for communicating data using a configuration for XR received from the CU, which can be implemented in a DU of a distributed base station; and

FIG. 10B is a flow diagram of another example method for communicating data using a configuration for XR received from the CU, but with an additional determination of whether the UE supports certain functionality related to XR.

### DETAILED DESCRIPTION OF THE DRAWINGS

A distributed base station can implement the techniques of this disclosure to support one or more PDU Set QoS parameters for a QoS flow in a PDU session, and/or support parameters for XR traffic. A PDU Set includes one or more PDUs carrying a payload of one unit of information generated at the application level (e.g. frame(s) or video slice(s) etc. for a XR services). As discussed in more detail below, a CU can receive PDU Set QoS parameters from a CN and, depending on the implementation or scenario, configure the DU with these or related PDU Set QoS parameter, and communicate traffic using PDU Set information, which the CN may provide along with data packets. The DU can receive one or more PDU Set QoS parameters from the CU and communicate traffic in accordance with the PDU Set QoS parameters.

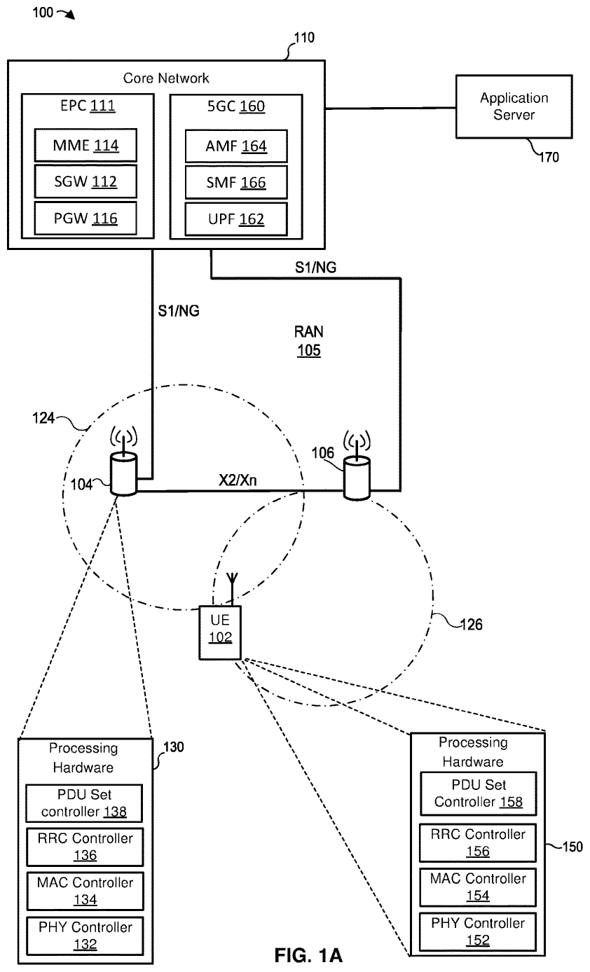

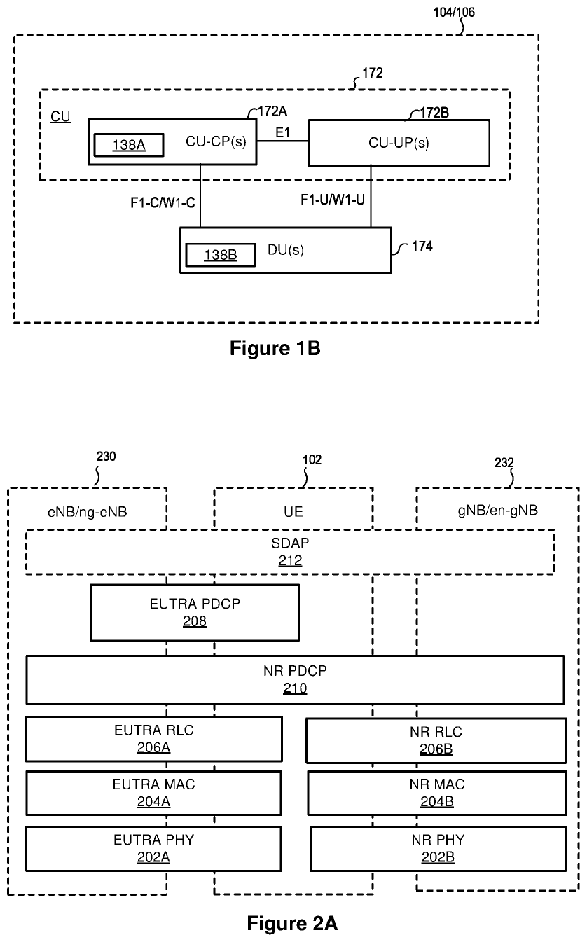

Referring first to FIG. 1A, an example wireless communication system 100 can implement one or more of these techniques. The wireless communication system 100 includes a UE 102, a base station (BS) 104, a base station 106 and a core network (CN) 110. The base stations 104 and 104 operate in a radio access network (RAN) 105. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can operate as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage Protocol Data Unit (PDU) sessions.

The SMF 166 can establish a PDU session for routing traffic between the UE 102 and an application server (AS) 170 operating outside the CN 110. The traffic can include downlink traffic traveling from the AS 170 to the UE 102, uplink traffic traveling from the UE 102 to the AS 170, or both. The traffic in some scenarios is XR traffic generally associated with low latency. In some scenarios, the CN 110 generates PDU Set information for the RAN 105 for handling PDUs as sets, as discussed below.

As illustrated in FIG. 1A, the base station 104 supports a cell 124, and the base station 106 supports a cell 126. The cells 124 and 126 can partially overlap, so that the UE 102 can communicate in DC with the base station 104 and the base station 106, where one of the base stations 104 and 106 is an MN and the other is an SN. The base station 104 and base station 106 can support additional cell(s) (not shown in FIG. 1A). The base station 104 can operate the cells 124 and/or additional cell(s) via one or more transmit and receive points (TRPs).

In general, the RAN 105 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include a RLC controller (not show in FIG. 1A) configured to perform RLC functions with one or more user devices. The processing hardware 130 can further include a PDCP controller (not show in FIG. 1A) configured to perform PDCP functions with one or more user devices. The processing hardware 130 can further include an RRC controller 136 to implement procedures and messaging at the RRC sublayer of the protocol communication stack. For example, the RRC controller 132 may be configured to support RRC messaging associated with resource configuration and reconfiguration procedure, handover procedures, and/or to support the necessary operations when the base station 104 operates as an MN relative to an SN or as an SN relative to an MN.

A PDU Set controller 138 can manage PDU Set QoS parameters, PDU Set information, etc. to support PDU-Set-based handling of traffic between the UE 102 and the CN 110. When the base station 104 is a distributed base station, a CU PDU Set controller 138A can operate in a CU, and a DU PDU Set controller 138B can operate in a DU (see FIG. 1B). The base station 106 can include processing hardware that is similar to processing hardware 130 and can support similar functionality

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing for communication with the base station 104 or 106, and communicating UL/DL MAC PDUs with the base station 104 or 106. The processing hardware 150 can further include an RRC controller 156 to implement procedures and messaging at the RRC sublayer of the protocol communication stack. The processing hardware 130 can further include an RLC controller (not show in FIG. 1A) configured to perform RLC functions with the base station 104 or 106. The processing hardware 130 can further include a PDCP controller (not show in FIG. 1A) configured to perform PDCP functions with the base station 104 or 106. A PDU Set controller 158 can support PDU-Set-based handling of traffic between the UE 102 and the CN 110.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

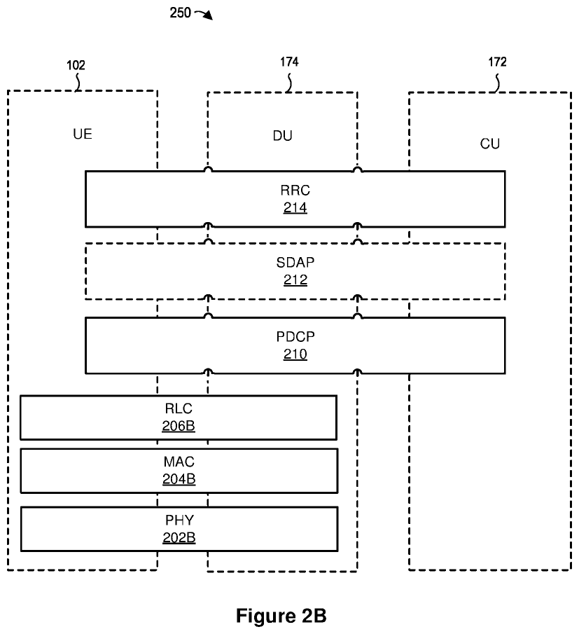

FIG. 2A illustrates, in a simplified manner, an example protocol stack 200 according to which the UE 102 can communicate with an eNB/ng-eNB 230 or a gNB 232 (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

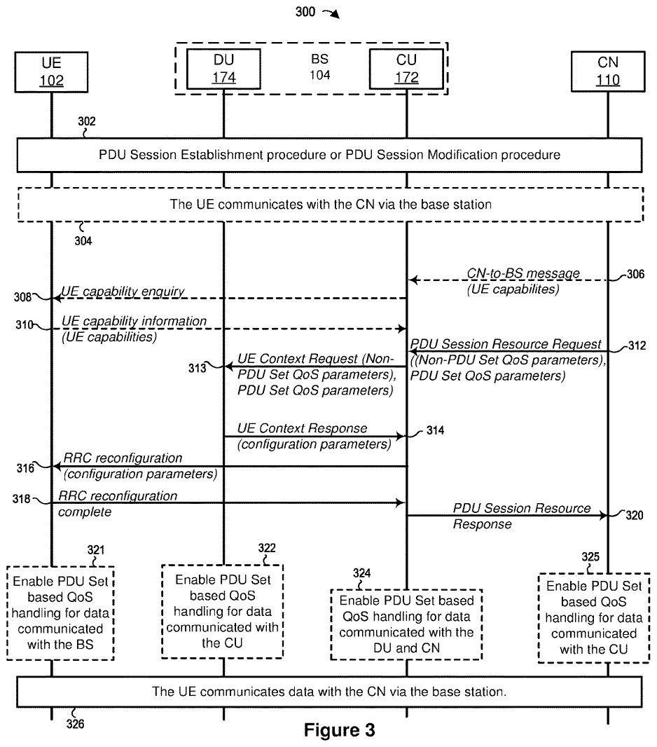

Referring first to FIG. 3, in a scenario 300, the base station 104 includes a CU 172 and a DU 174, and the UE 102 initially performs 302 a PDU Session Establishment procedure or a PDU Session Modification procedure with the CN 110 via the base station 104 or the base station 106 (not shown in FIG. 3) to establish or modify a PDU session for performing one or more services that requires high data rate and low latency transmission. For example, the service(s) include XR services and/or cloud games. During the PDU Session Establishment procedure, the UE 102 transmits a PDU Session Establishment Request message to the CN 110 via the base station (e.g., the base station 104 or 106). In response, the CN 110 can send a PDU Session Establishment Accept message to the UE 102 via the base station. In response to the PDU Session Establishment Accept message, the UE 102 then transmits a PDU Session Establishment Complete message to the CN 110 via the base station. In the PDU Session Modification procedure, the UE 102 transmits a PDU Session Modification Request message to the CN 110 via the base station. In response, the CN 110 can send a PDU Session Modification Command message to the CN 110 via the base station. In response to the PDU Session Modification Command message, the UE 102 then transmits a PDU Session Modification Complete message to the CN 110 via the base station.

In some implementations, the UE 102 can include, in the PDU Session Establishment Request message or PDU Session Modification Request message, a PDU session ID identifying the PDU session, slice information, and/or a particular data network name (DNN). In some implementations, the CN 110 may include the PDU session ID in the PDU Session Establishment Accept message or PDU Session Modification Command message to indicate a successful establishment or modification of the PDU session. In some implementations, the slice information indicates a specific slice configured for the service(s). For example, the slice information can be a Single Network Slice Selection Assistance Information (S-NSSAI) or includes a portion of the S-NSSAI. In other implementations, the UE 102 can include, in the PDU Session Establishment Request message or PDU Session Modification Request message, UE-requested quality of service (QoS) parameters that the UE 102 requires to perform the service(s).

After performing the procedure 302, the UE 102 communicates 304 with the CN 110 via the base station 104. While communicating with the UE 102, the CU 172 can receive 306, from the CN 110, a CN-to-BS message including UE capabilities of the UE 102. The CU 172 can transmit a CU-to-DU message including the UE capabilities to the DU 174 (not shown to avoid clutter). The CU-to-DU message can be a F1 Application Protocol (F1AP) message, a UE Context Setup Request message or a UE Context Modification Request message. Alternatively, the CU 172 transmits 308 a UE capability enquiry message to the UE 102 via the DU 174 to inquire regarding the UE capabilities. In response, the UE 102 transmits 310, to the CU 172 via the DU 174, a UE capability information message including the UE capabilities.

In some implementations, the UE capabilities include an indication dedicated specifically to the support of one or more functions/features for enhancing communication of data requiring high data rate and low latency, such as XR data or cloud gaming data. For example, the function(s)/feature(s) include multiple configured grant (CG) Physical Uplink Shared Channel (PUSCH) transmission occasions in a period of a single CG PUSCH configuration, a dynamic indication of unused CG PUSCH occasion(s) based on UCI by the UE, buffer status reporting (BSR) enhancements including at least a dedicated buffer status table(s), delay reporting of buffered data in uplink, a provisioning of XR traffic assistance information for DL and UL (e.g. periodicity) and/or PDU-Set-based QoS handling (e.g., discard operation of PDU Set(s)). A PDU Set includes one or more PDUs carrying a payload of one unit of information generated at the application level (e.g. frame(s) or video slice(s) etc. for a XR services).

During or after the procedure 302, or during the procedure 304, the CN 110 transmits 312 a PDU Session Resource Request message to the CU 172 to request the CU 172 to assign resources for the PDU session and one or more QoS flows for the UE 102. The QoS flow(s) is/are associated with the PDU session. In some implementations, the CN 110 can include a first set of PDU Set QoS parameters for the PDU session or the QoS flow(s) in the PDU Session Resource Request message. In one implementation, the CN 110 includes the first set of PDU Set QoS parameters to request or configure PDU-Set-based QoS handling for the UE 102 (e.g., the PDU session or the QoS flow(s)). After (e.g., in response to) receiving 312 the PDU Session Resource Request message, the CU 172 transmits 313 a UE Context Request message for the PDU session or QoS flow(s) to the DU 174. In some implementations, the CU 172 includes a second set of PDU Set QoS parameters in the UE Context Request message to request or configure PDU-Set-based QoS handling for the UE 102 (e.g., the PDU session or the QoS flow(s)). In some implementations, the second set of PDU Set QoS parameters is the same as, or identical, to the first set of PDU Set QoS parameters. In other implementations, the second set of PDU Set QoS parameters is different from the first set of PDU Set QoS parameters. In some implementations, the CU 172 determines the second set of PDU Set QoS parameters based on the first set of PDU Set QoS parameters. In such cases, the CU 172 ensures that the second set of PDU Set QoS parameters satisfies the first set of PDU Set QoS parameters. For example, the CU 172 can make the second set of PDU Set QoS parameters to be more stringent than the first set of PDU Set QoS parameters, to account for the latency in the F1-U connection between the CU 172 and DU 174, data processing time at the CU 172, and/or data processing time at the DU 174.

In some implementations, the CU 172 determines to include, or includes, the second set of PDU Set QoS parameters in the UE Context Request message, if the CU 172 and/or DU 174 support(s) PDU-Set-based QoS handling. If at least one of the CU 172 and DU 174 does not support PDU-Set-based QoS handling, the CU 172 does not include PDU Set QoS parameters (e.g., the second set of PDU Set QoS parameters) in the UE Context Request message. In other implementations, the CU 172 determines to include, or includes, the second set of PDU Set QoS parameters in response to receiving at least one of the capabilities dedicated to high data rate and low latency. If the UE capabilities do not include these capabilities, the CU 172 can refrain from including the second set of PDU Set QoS parameters in the UE Context Request message.

In some implementations, the CN 110 can include a respective set of PDU Set QoS parameters for each of the QoS flow(s) indicated 312 in the PDU Session Resource Request message. In such cases, the CU 172 can include 313 a respective set of PDU Set QoS parameters in the UE Context Request message. In some implementations, for each of the QoS flow(s), the corresponding set of PDU Set QoS parameters in the UE Context Request message is the same as or identical to the corresponding set of PDU Set QoS parameters in the PDU Session Resource Request message. In other implementations, for each of the QoS flow(s), the CU 172 determines the corresponding set of PDU Set QoS parameters in the UE Context Request message based on the corresponding set of PDU Set QoS parameters in the PDU Session Resource Request message.

In some implementations, the CN 110 includes 312, in the PDU Session Resource Request message, a first set of non-PDU Set QoS parameters (i.e., QoS parameter(s) not related to a PDU Set). In such cases, the CU 172 can include 313 a second set of non-PDU Set QoS parameters in the UE Context Request message. In some implementations, the second set of non-PDU Set QoS parameters is the same as or identical to the first set of non-PDU Set QoS parameters. In other implementations, the CU 172 determines the second set of non-PDU Set QoS based on the first set of non-PDU Set QoS parameters. In some implementations, the CN 110 includes 312 a respective set of non-PDU Set QoS parameter(s) for each of the QoS flow(s) in the PDU Session Resource Request message. In such cases, the CU 172 can include a respective set of non-PDU Set QoS parameters for each of the QoS flow(s) in the UE Context Request message. In some implementations, for each of the QoS flow(s), the corresponding set of non-PDU Set QoS parameters in the UE Context Request message is the same as, or identical, to the corresponding set of non-PDU Set QoS parameters in the PDU Session Resource Request message. In other implementations, for each of the QoS flow(s), the CU 172 determines the corresponding set of non-PDU Set QoS parameters in the UE Context Request message based on the corresponding set of non-PDU Set QoS parameters in the PDU Session Resource Request message. In other implementations, the CN 110 does not include 312, in the PDU Session Resource Request message, non-PDU Set QoS parameters for the PDU session or QoS flow(s). In such cases, the CU 172 can refrain from including 313, in the UE Context Request message, non-PDU Set QoS parameters for the PDU session or QoS flow(s).

In some implementations, a set of one or more non-PDU Set QoS parameters (as described above) includes a QoS identifier descriptor, a maximum flow bit rate for DL, a maximum flow bit rate for UL, a guaranteed flow bit rate for DL, and/or a guaranteed flow bit rate for UL.

In some implementations, the CN 110 includes 312 a PDU Session ID identifying the PDU session in the PDU Session Resource Request message. In some implementations, the CN 110 includes one or more QoS flow identifiers identifying the QoS flow(s) in the PDU Session Resource Request message. Each of the QoS flow identifier(s) identifies a particular QoS flow of the QoS flow(s). In some implementations, the CU 172 includes the QoS flow identifier(s) in the UE Context Request message and associates each of the QoS flow identifier(s) with the respective set of the PDU Set QoS parameters and/or the respective non-PDU Set QoS parameters.

In response to receiving 313 the UE Context Request message, the DU 174 transmits 314 a UE Context Response message to the CU 172. In some implementations, the DU 174 assigns resources for the PDU Session or QoS flow(s), generates configuration parameters for communicating data associated with the PDU session or QoS flow(s), and includes the configuration parameters in the UE Context Response message. In some implementations, if the DU 174 supports PDU-Set-based QoS handling or the second set of PDU Set QoS parameters, the DU 174 includes, in the UE Context Response message, a confirmation information indicating that the DU 174 applies (e.g., performs) PDU-Set-based QoS handling (e.g., for the PDU session or QoS flow(s)), based on the second set of PDU Set QoS parameters. The confirmation in at least some of the implementations is explicit. In other implementations, if the DU 174 does not support PDU-Set-based QoS handling or the second set of PDU Set QoS parameters, the DU 174 includes an unsupported information or indication (e.g., a cause value) in the UE Context Response message to indicate that the DU 174 does not support PDU-Set-based QoS handling or the second set of PDU Set QoS parameters. In other implementations, the DU 174 implicitly indicates that the DU 174 supports PDU-Set-based QoS handling or the second set of PDU Set QoS parameters, by excluding the unsupported information in the UE Context Response message.

In some implementations, if the DU 174 supports the second set of PDU Set QoS parameters or PDU-Set-based QoS handling, the DU 174 assigns resources for the PDU Session or QoS flow(s) and/or generates some or all of the configuration parameters, based on the second set of PDU Set QoS parameters. In some implementations, if the DU 174 supports the second set of PDU Set QoS parameters or PDU-Set-based QoS handling, the DU 174 enables 322 PDU-Set-based QoS handling (e.g., for the PDU session or QoS flow(s)). In one implementation, the DU 174 enables 322 PDU-Set-based QoS handling after (e.g., in response to) receiving 313 the second set of PDU Set QoS parameters or the UE Context Request message. In other implementations, the DU 174 enables 322 PDU-Set-based QoS handling (e.g., for the PDU session or QoS flow(s)), regardless of, or before, receiving 313 the second set of PDU Set QoS parameters or the UE Context Request message.

In some implementations, the configuration parameters include one or more configuration parameters to enable PDU-Set-based QoS handling at the UE 102, and the UE 102 enables 321 PDU-Set-based QoS handling in response to receiving 316 the configuration parameter(s). In some implementations, the DU 174 additionally accounts for the second set of non-PDU Set QoS parameters when configuring the configuration parameter(s) and/or assigning resources for the UE 102. In other implementations, the DU 174 ignores the second set of non-PDU Set QoS parameters. By properly assigning resources for the UE 102 and/or configuring the configuration parameter(s), the DU 174 ensures that the base station 104 communicates 326 data associated with the PDU session or QoS flow(s) with the UE 102 in compliance with the PDU Set QoS parameters and/or non-PDU Set QoS parameters.

In other implementations, if the DU 174 does not support the second set of PDU Set QoS parameters or PDU-Set-based QoS handling, the DU 174 assigns resources for the PDU Session or QoS flow(s) and/or generates the configuration parameters, based on the second set of non-PDU Set QoS parameters. If the DU 174 does not support the second set of PDU Set QoS parameters or PDU-Set-based QoS handling and the UE Context Request message does not include non-PDU Set QoS parameters, the DU 174 assigns resources for the PDU Session or QoS flow(s) and/or generates the configuration parameters, based on predefined non-PDU Set QoS parameters or predefined rules. In such implementations, the configuration parameters do not include a configuration parameter enabling PDU-Set-based QoS handling at the UE 102. By properly assigning resources and/or configuring the configuration parameter(s) for the UE 102, the DU 174 ensures that the base station 104 communicates 326 data associated with the PDU session or the QoS flow(s) with the UE 102 in compliance with the non-PDU Set QoS parameters.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively. In some other implementations, the DU 174 includes the configuration parameters in a UE Context Modification Required message instead of the UE Context Response message and transmits the UE Context Modification Required message to the CU 172. In this case, the CU 172 can transmit a UE Context Modification Confirm message to the DU 174 in response to the UE Context Modification Required message.

In some implementations, the first and/or the second set of PDU Set QoS parameters includes a PDU Set Delay Budget (PSDB), a PDU Set Error Rate (PSER), and/or a PDU Set Integrated Handling Information (PSIHI). The PSDB can define an upper limit for a delay time that a PDU Set may experience for the transfer between the UE 102 and the CN 110 (e.g., the UPF 162). For DL, the delay time may be the time interval between the reception time of the first PDU of a DL PDU Set at the CN 110 (e.g., the UPF 162) and the time when the UE has successfully received all the PDUs of the DL PDU Set. For UL, the delay time may be the time interval between the reception time of the first PDU of a UL PDU Set at the UE 102 (e.g., the reception time where a protocol layer of the UE 102 receives the first PDU from an application) and the time when the CN 110 (e.g., the UPF 162) has successfully received all the PDUs of the UL PDU Set. The protocol layer can be SDAP 212, PDCP 210, RLC 206 or MAC 204. In some implementations, the application can be an operating system (e.g., Android, iOS, Windows or Linux).

In some implementations, the PSDB applies to a DL PDU Set for the UE 102 the CN 110 (e.g., the UPF 162) transmits, and applies to the UL PDU Set the UE 102 transmits. The PSER defines an upper limit for a rate of PDU Sets that have been processed by a sender (e.g., the UE 102, CU 172 or DU 174) of a link layer protocol (e.g., RLC 206) but that are not successfully delivered by a corresponding receiver to an upper layer (e.g., PDCP 210) of the receiver. Thus, the PSER defines an upper limit for a rate of non-congestion related PDU Set losses. The purpose of the PSER is to allow appropriate link layer protocol configurations (e.g. PDCP configuration, RLC bearer configuration, MAC configuration and/or HARQ configuration) in the configuration parameters. The PSIHI indicates whether all PDUs of a PDU Set are needed for the application layer at the receiver side to use the PDU Set by.

After (e.g., in response to) receiving the UE Context Response message or UE Context Modification Required message, the CU 172 transmits 316 an RRC reconfiguration message including the configuration parameters to the UE 102 via the DU 174. In response, the UE 102 transmits 318 an RRC reconfiguration complete message to the CU 172 via the DU 174. In some implementations, the CU 172 includes, in the RRC reconfiguration message, one or more DRB configurations configuring one or more DRBs associated with the PDU session and/or QoS flow(s). Each of the DRB configuration(s) can include a PDCP configuration and/or an SDAP configuration. In some implementations, the configuration parameters include one or more RLC bearer configurations, each configuring a RLC bearer for a particular DRB, and/or include a MAC configuration. In some implementations, the CU 172 configures the PDCP configuration(s) and/or SDAP configuration(s) based on the PDU Set QoS parameters.

Before or after receiving 314 the UE Context Response message or receiving the RRC reconfiguration complete message, the CU 172 transmits 320 a PDU Session Resource Response message to the CN 110 in response to receiving 312 the PDU Session Resource Request message. In some implementations, if the CU 172 and DU 174 support PDU-Set-based QoS handling as described above, the CU 172 includes 320, in the PDU Session Resource Response message, confirmation information indicating that the base station 104 (e.g., the CU 172 and/or DU 174) applies (e.g., performs) PDU-Set-based QoS handling based on the first set of PDU Set QoS parameters. In other implementations, if the CU 172 does not support PDU-Set-based QoS handling (e.g., based on the first set of PDU Set QoS parameters), and/or the DU 174 does not support PDU-Set-based QoS handling (e.g., based on the second set of PDU Set QoS parameters), the CU 172 includes unsupported information (e.g., a cause value) in the PDU Session Resource Response message to indicate that the base station 104 does not support PDU-Set-based QoS handling or the first set of PDU Set QoS parameters. In some other implementations, if the CU 172 and DU 174 support PDU-Set-based QoS handling as described above, the CU 172 includes 320, in the PDU Session Resource Response message, an implicit indication that the base station 104 supports the first set of PDU Set QoS parameters or PDU-Set-based QoS handling, by excluding the unsupported information or indication from the PDU Session Resource Response message.

In some implementations, the PDU Session Resource Request message and the PDU Session Resource Response message are a PDU Session Resource Setup Request message and a PDU Session Resource Setup Response message, respectively. In other implementations, the PDU Session Resource Request message and the PDU Session Resource Response message are a PDU Session Resource Modify Request message and a PDU Session Resource Modify Response message, respectively.

After receiving the PDU Session Resource Response message, the CN 110 (e.g., the UPF 162) communicates 326 data packets (e.g., data packets for XR or clouding gaming) with the UE 102 via the base station 104. For example, the CN 110 transmits 326 data packets associated with the QoS flow for the UE 102 to the CU 172, which in turn transmits 326 the data packets to the DU 174. The DU 174 transmits 326 the data packets to the UE 102 based on the configuration parameters 316 and resources assigned for the UE 102. After receiving 316 the RRC reconfiguration complete message, the UE 102 transmits 326 data packets associated with the QoS flow to the DU 174 using the configuration parameters. The DU 174 in turn transmits 326 the data packets to the CU 172. The CU 172 transmits 326 the data packets to CN 110.

In some implementations, the CN 110 transmits 326 data packets associated with the QoS flow to the CU 172 using a GPRS Tunneling Protocol User Plane (GTP-U) protocol. In some implementations, the CN 110 performs PDU Set QoS handling to transmit 326 the data packets to the CU 172, e.g., based on the PDU Set QoS parameters (e.g., the first set of PDU Set QoS flow). To perform PDU-Set-based QoS handling, the CN 110 groups data packets for the UE 102 into PDU Sets and determines PDU Set information for each data packet in each PDU Set. The PDU Set information includes at least one of a PDU Set Sequence Number, an indication of End PDU of the PDU Set (i.e., the last data packet in the PDU Set), a PDU Sequence Number (i.e., a sequence number for a data packet) within a PDU Set, a PDU Set Size in bytes, and/or PDU Set Importance which identifies the relative importance of a PDU Set compared to other PDU Sets within the QoS Flow. For each data packet the CN transmits 326 to the UE 102, the CN 110 generates a GTP-U packet, including the data packet and the PDU Set information for the data packet.

In some implementations, the CN 110 includes the PDU Set information in a GTP-U header of the GTP-U packet. The CN 110 transmits 326 the GTP-U packet to the CU 172. When the CU 172 receives the GTP-U packet, the CU 172 retrieves the data packet from the GTP-U packet. If the CU 172 supports PDU-Set-based QoS handling, the CU 172 performs PDU-Set-based QoS handling for the data packet in the GTP-U packet based on the PDU Set information and the PDU Set QoS parameters (e.g., the first, second or third set of PDU Set QoS parameters). In some implementations, the CU 172 transmits 326 the data packet to the DU 174 based on the GTP-U protocol. In some implementations, the CU 172 generates a GTP-U packet including the data packet and PDU Set information for the data packet, and transmits the GTP-U packet to the DU 174. The CU 172 can include the PDU Set information in a GTP-U header of the GTP-U packet. In some implementations, the CU 172 determines whether to include the PDU Set information in the GTP-U packet based on whether the DU 174 supports PDU-Set-based QoS handling. If the DU 174 supports PDU-Set-based QoS handling, the CU 172 includes the PDU Set information in the GTP-U packet. Otherwise, if the DU 174 does not support PDU-Set-based QoS handling, the CU 172 does not include the PDU Set information in the GTP-U packet.

In some implementations, the CU 172 uses the PDU Set Importance for PDU Set level packet discarding in case of congestion at the base station 104 (e.g., the CU 172 and/or DU 174). In other implementations, the CU 172 receives from the CN 110 a first GTP-U packet and a second GTP-U packet associated with the QoS flow for the UE 102. The first GTP-U packet includes first PDU Set information and a first data packet. The first PDU Set information includes a first PDU Sequence Number and a PDU Set sequence number. The CU 172 also receives a second GTP-U packet associated with the QoS flow for the UE 102 and the second GTP-U packet includes second PDU Set information and a second data packet. The second PDU Set information includes a second PDU Sequence Number and the PDU Set sequence number. The CU 172 prioritizes transmission for the first data packet over the second data packet based on the first PDU Sequence Number and the second PDU Sequence Number. If the first PDU Sequence Number precedes the second PDU Sequence Number in sequence, the CU 172 transmits the first data packet to the DU 174 and then transmits the second data packet to the DU 174.

In some implementations, the DU 174 schedules the UE 102 to transmit 326 data packets associated with the QoS flow to the DU 174 based on the second PDU Set QoS parameters and/or the second set of non-PDU Set QoS parameters. The DU 174 ensures that the data packets received from the UE 102 and transmitted to the CU 172 follow the second set of PDU Set QoS parameters and/or the second set of non-PDU Set QoS parameters. In some implementations, when the DU 174 receives 326 a data packet from the UE 102, the DU 174 generates a GTP-U packet including the data packet and does not include PDU Set information in the GTP-U packet. In one implementation, the DU 174 does not include PDU Set information in the GTP-U packet, because the UE 102 does not transmit PDU Set information for the data packet to the DU 174. If the UE 102 transmits PDU Set information for the data packet to the DU 174, the DU 174 can include the PDU Set information in the GTP-U packet. For example, the DU 174 includes the PDU Set information in a GTP-U header of the GTP-U packet. When receiving the GTP-U packet, the CU 172 generates a GTP-U packet including the data packet and transmits the GTP-U packet to the CN 110. When the DU 174 includes the PDU Set information in the GTP-U packet generated by the DU 174, the CU 172 includes PDU Set information in the GTP-U packet (c.g., a GTP-U header of the GTP-U packet) the CU 172 generated. In some implementations, the PDU Set information in the GTP-U packet the CU 182 generated is the same as, or identical to, the PDU Set information in the GTP-U packet the DU 174 generated. In other implementations, the PDU Set information in the GTP-U packet the CU 172 generated is different from the PDU Set information in the GTP-U packet the DU 174 generated. In some implementations, the CU 172 generates the PDU Set information based on the PDU Set information received from the DU 174.

In some implementations, the CN 110 enables 325 PDU-Set-based QoS handling for the PDU session or QoS flow, after (e.g., in response to) receiving 320 the PDU Session Resource Response message. In other implementations, the CN 110 enables 325 PDU-Set-based QoS handling for the PDU session or QoS flow, regardless of, or before, receiving 320 the PDU Session Resource Response message. In some implementations, the CU 172 enables 324 PDU-Set-based QoS handling for the PDU session or QoS flow in response to receiving 312 the PDU Session Resource Request message or the first set of PDU Set QoS parameters. In some implementations, if the CU 172 receives, from the CN 110, a PDU Session Resource Release Command message for the PDU session, the CU 172 disables PDU-Set-based QoS handling for the PDU session or QoS flow. In some implementations, if the CU 172 receives, from the CN 110, a PDU Session Resource Modify Request message releasing the QoS flow, the CU 172 disables PDU-Set-based QoS handling for the QoS flow. In some implementations, if the CU 172 receives a PDU Session Resource Request message (e.g., a PDU Session Resource Setup Request message or a PDU Session Resource Modify Request message) from the CN 110, excluding PDU Set QoS parameters, for a PDU session or a QoS flow for a UE (e.g., the UE 102 or another UE), the CU 172 disables, or refrains from enabling, PDU-Set-based QoS handling for the PDU session or QoS flow.

In some implementations, if the CU 172 does not support the PDU-Set-based QoS handling and receives 326, from the CN 110, GTP-U packets each including a data packet and PDU Set information, the CU 172 ignores the PDU Set information. In some implementations, if the CN 110 determines that the base station 104 (e.g., the CU 172 and/or DU 174) does not support the PDU-Set-based QoS handling, the CN 110 refrains from including PDU Set information in a GTP-U packet that includes a data packet for the UE 102.

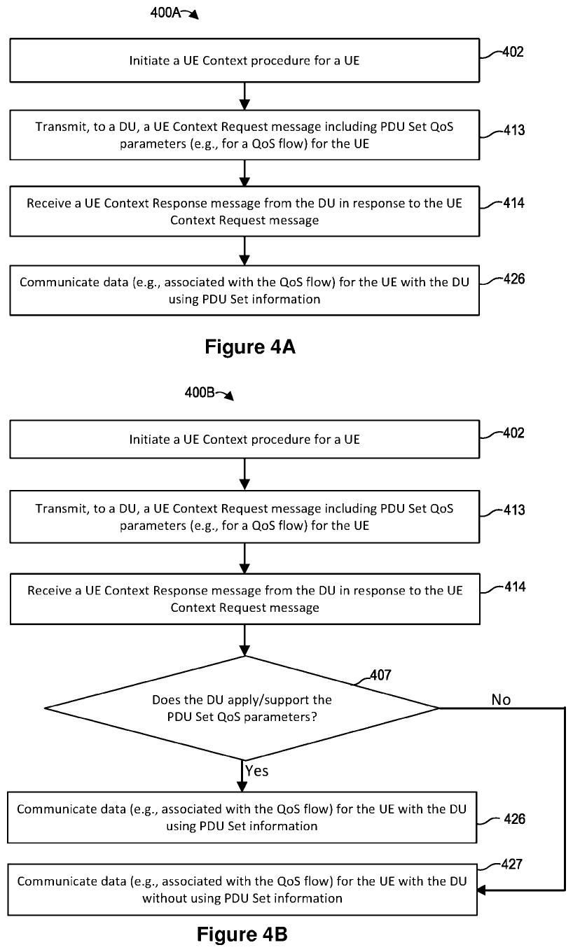

Next, several example methods which a DU or a DU can implement are discussed with reference to FIGS. 4A-10B. Generally speaking, similar events in FIGS. 4A-10B are labeled with the similar reference numbers that share two least significant digits, with differences discussed below where appropriate. For example, event 413 is similar to event 513, event 414 is similar to event 414, and event 426 is similar to event 526.

FIG. 4A is a flow diagram of an example method 400A for transmitting PDU Set QoS parameters to a DU (e.g., the DU 174 of the base station 104) for PDU-Set-based QoS handling, which can be implemented by a CU (e.g., the CU 172 of the base station 104).

The method 400A begins at block 402, where the CU initiates a (first) UE Context procedure for a (first) UE (e.g., events 313, 314). At block 413, the CU transmits a (first) UE Context Request message including PDU Set QoS parameters (e.g., for a (first) PDU session or a (first) QoS flow) for the (first) UE to a (first) DU (e.g., event 313) in response to the initiation. At block 414, the CU receives a (first) UE Context Response message from the (first) DU in response to the (first) UE Context Request message (e.g., event 314). At block 426, the CU communicates data (e.g., associated with the (first) PDU session or the (first) QoS flow) for the (first) UE with the (first) DU using PDU Set information (e.g., event 326).

In some implementations, the CU initiates a second UE Context procedure for a second UE (e.g., events 313, 314). In response to the initiation, the CU transmits a second UE Context Request message excluding PDU Set QoS parameters (e.g., for a second PDU session or a second QoS flow) for the second UE to a second DU (e.g., event 313). The CU receives a second UE Context Response message from the second DU in response to the second UE Context Request message (e.g., event 314). The CU communicates data (e.g., associated with the second PDU session or the second QoS flow) for the second UE with the second DU without using PDU Set information (e.g., event 326).

In some implementations, the first UE and second UE are the same UE. In other implementations, the first UE and second UE are different UEs. In some implementations, the first DU and second DU are the same DU. In other implementations, the first DU and second DU are different DUs. In some implementations, the first UE and second UE are the same UE. In other implementations, the first UE and second UE are different UEs. In some implementations, the first UE Context Request message and second UE Context Request message are the same UE Context Request message, and the first UE Context Response message and second UE Context Response message are the same UE Context Response message. In other implementations, the first UE Context Request message and second UE Context Request message are different UE Context Request messages, and the first UE Context Response message and second UE Context Response message are different UE Context Response messages.

FIG. 4B is a flow diagram of an example method 400B similar to the method 400A, except that the method 400B includes blocks 407 and 427. At block 407, the CU determines whether the DU applies the PDU Set QoS parameters. If the CU determines that the DU applies or supports the PDU Set QoS parameters at block 407, the flow proceeds to block 426. Otherwise, if the CU determines that the DU does not apply or support the PDU Set QoS parameters at block 407, the flow proceeds to block 427. At block 427, the CU communicates data (e.g., associated with the PDU session or the QoS flow) for the UE with the first DU without using PDU Set information (e.g., event 326).

In some implementations, the UE Context Response message indicates whether the DU applies or supports the PDU Set QoS parameters. If the CU determines that the UE Context Response message indicates that the DU applies or supports the PDU Set QoS parameters, the CU communicates data (e.g., associated with the PDU session or the QoS flow) for the UE with the DU using PDU Set information (e.g., event 326). Otherwise, if the CU determines that the UE Context Response message indicates that the DU does not apply or support the PDU Set QoS parameters, the CU communicates data (e.g., associated with the PDU session or the QoS flow) for the UE without the DU using PDU Set information (e.g., event 326). In some implementations, the UE Context Response message includes a cause indicating that the DU does not apply or support the PDU Set QoS parameters, and the UE Context Response message excludes the cause to indicate that the DU applies or supports the PDU Set QoS parameters.

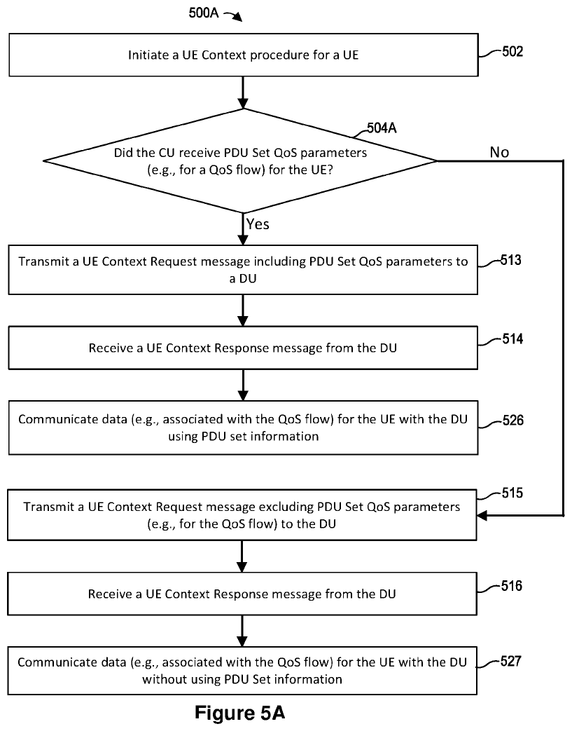

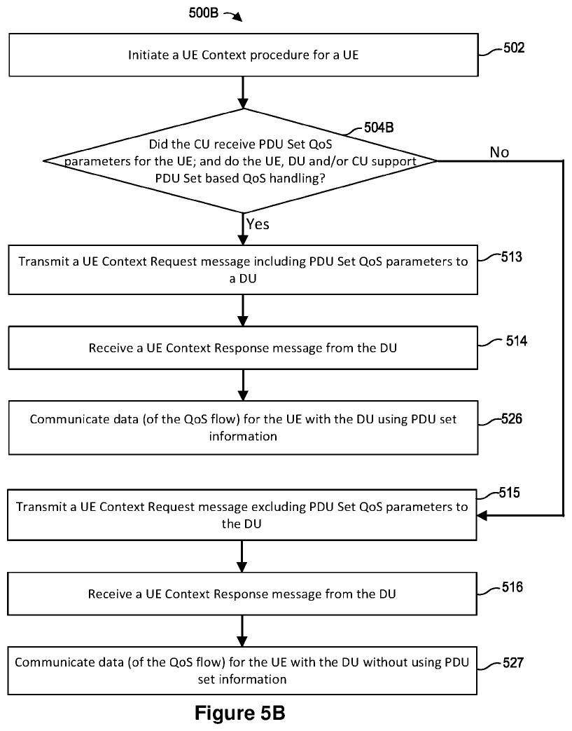

FIG. 5A is a flow diagram of an example method 500A for transmitting PDU Set QoS parameters to a DU (e.g., the DU 172 of the base station 104) for PDU-Set-based QoS handling, which can be implemented by a CU (e.g., the CU 172 of the base station 104).

The method 500A begins at block 502, where the CU initiates a UE Context procedure for a UE (e.g., events 313, 314). At block 504A, the CU determines whether the CU receives PDU Set QoS parameters (e.g., for a PDU session or a QoS flow) for the UE. If the CU determines that the CU receives PDU Set QoS parameters (e.g., for a PDU session or a QoS flow) for the UE at block 504A, the flow proceeds to block 513. At block 513, the CU transmits a UE Context Request message including PDU Set QoS parameters to a DU (e.g., event 313). At block 514, the CU receives a UE Context Response message from the DU (e.g., event 314). At block 526, the CU communicates data (e.g., associated with the PDU session or the QoS flow) for the UE with the DU using PDU set information (e.g., event 326).

Otherwise, if the CU determines that the CU does not receive PDU Set QoS parameters (e.g., for the PDU session or the QoS flow) for the UE at block 504A, the flow proceeds to block 515. At block 515, the CU transmits a UE Context Request message excluding PDU Set QoS parameters to the DU. At block 516, the CU receives a UE Context Response message from the DU. At block 527, the CU communicates data (e.g., associated with the PDU session or the QoS flow) for the UE with the DU without using PDU Set information.

FIG. 5B is a flow diagram of an example method 500B similar to the method 500A, except that the method 500B includes block 504B instead of block 504A. At block 504B, the CU determines whether the CU receives PDU Set QoS parameters (e.g., for a PDU session or a QoS flow) for the UE and the UE and/or DU support PDU Set handling. If the CU determines that the CU receives PDU Set QoS parameters (e.g., for a PDU session or a QoS flow) for the UE and the UE, DU and/or CU support(s) PDU Set handling at block 504B, the flow proceeds to blocks 513, 514, and 526. Otherwise, if the CU determines that the CU does not receive PDU Set QoS parameters (e.g., for the PDU session or the QoS flow) for the UE and/or the UE, DU and/or CU do/does not support PDU-Set-based QoS handling at block 504B, the flow proceeds to blocks 515, 516, and 527.

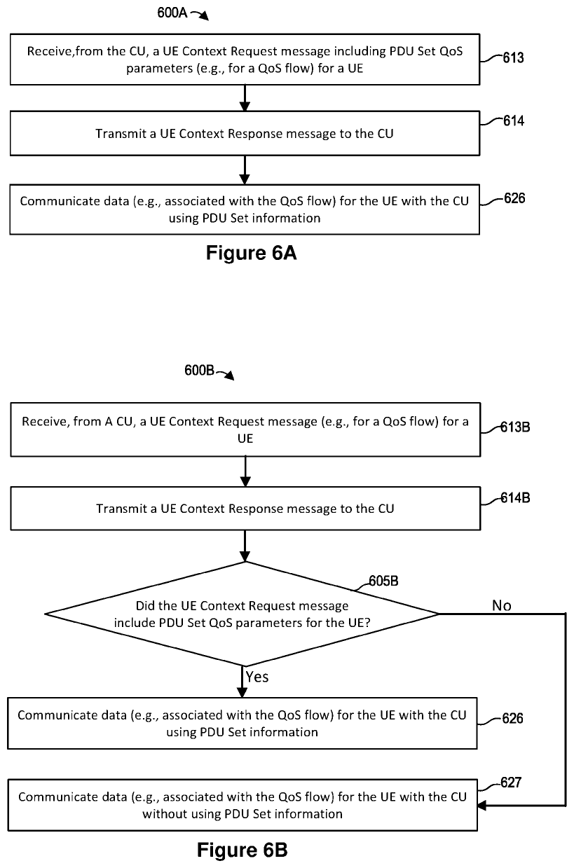

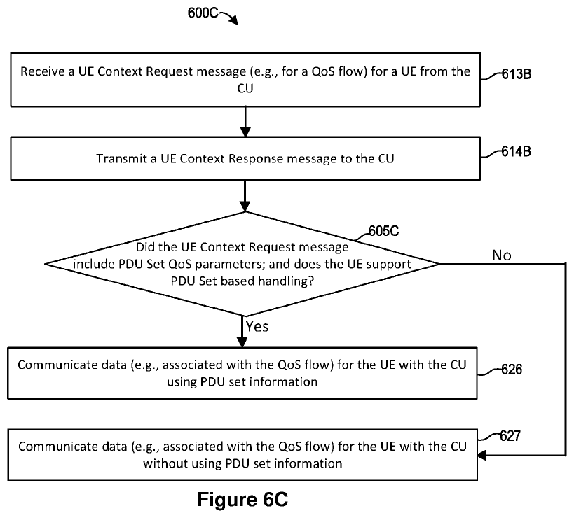

FIG. 6A is a flow diagram of an example method 600A for performing PDU-Set-based QoS handling on data received from a CU (e.g., the CU 172 of the base station 104), which can be implemented by a DU (e.g., the DU 174 of the base station 104).

The method 600A begins at block 613, where the DU receives a (first) UE Context Request message including PDU Set QoS parameters (e.g., for a (first) PDU session or a (first) QoS flow) for a (first) UE from the CU (e.g., event 313). At block 614, the DU transmits a (first) UE Context Response message to the CU in response to the (first) UE Context Response message (e.g., event 314). At block 626, the DU communicates data (e.g., associated with the (first) PDU session or the (first) QoS flow) for the (first) UE with the CU using PDU Set information (e.g., event 326).

In some implementations, the DU receives a second UE Context Request message excluding PDU Set QoS parameters (e.g., for a second PDU session or a second QoS flow) for a second UE from the CU. The DU transmits a second UE Context Response message to the CU in response to the second UE Context Request message. The DU communicates data (e.g., associated with the second PDU session or the second QoS flow) for the second UE with the CU without using PDU Set information.

In some implementations, the first UE and second UE are the same UE. In other implementations, the first UE and second UE are different UEs. In some implementations, the first UE and second UE are the same UE. In other implementations, the first UE and second UE are different UEs. In some implementations, the first UE Context Request message and second UE Context Request message are the same UE Context Request message, and the first UE Context Response message and second UE Context Response message are the same UE Context Response message. In other implementations, the first UE Context Request message and second UE Context Request message are different UE Context Request messages, and the first UE Context Response message and second UE Context Response message are different UE Context Response messages.

FIG. 6B is a flow diagram of an example method 600B generally similar to the method 600A. However, at block 613B, the DU receives a UE Context Request message (e.g., for a PDU session or a QoS flow) for the UE. At block 605B, the DU determines whether the UE Context Request message includes PDU Set QoS parameters (e. g,, for the PDU session or the QoS flow) for the UE. If the DU determines that the UE Context Request message includes PDU Set QoS parameters (e.g., for the PDU session or the QoS flow) for the UE at block 605B, the flow proceeds to block 626. Otherwise, if the DU determines that the UE Context Request message does not include PDU Set QoS parameters (e.g., for the PDU session or the QoS flow) for the UE at block 605B, the flow proceeds to block 627. At block 627, the DU communicates data (e.g., associated with the PDU session or the QoS flow) for the UE with the CU without using PDU Set information.

FIG. 6C is a flow diagram of an example method 600C similar to the method 600B, except that the method 600C includes block 605C instead of block 605B. At block 605C, the DU determines whether the UE Context Request message includes PDU Set QoS parameters (e.g., for the PDU session or the QoS flow) and the UE supports PDU Set handling. If the DU determines that the UE Context Request message includes PDU Set QoS parameters (e.g., for the PDU session or the QoS flow) and the UE support PDU-Set-based QoS handling at block 605C, the flow proceeds to block 626. Otherwise, if the DU determines that the UE Context Request message does not include PDU Set QoS parameters and/or the UE does not support PDU-Set-based QoS handling, the flow proceeds to block 627.

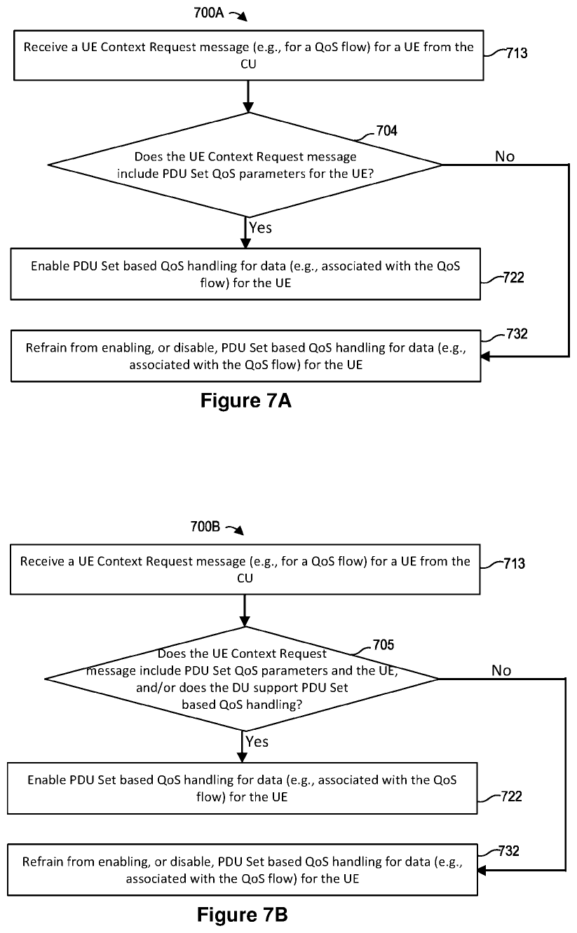

FIG. 7A is a flow diagram of an example method 700A for determining whether to enable PDU-Set-based QoS handling for data for a UE (e.g., the UE 102), which can be implemented by a DU (e.g., the DU 174 of the base station 104).

The method 700A begins at block 713, where the DU receives a (first) UE Context Request message (e.g., for a (first) PDU session or a (first) QoS flow) for a (first) UE from the CU (e.g., event 313). In some implementations, the DU transmits a (first) UE Context Response message to the CU in response to the (first) UE Context Request message (e.g., event 314). At block 704, the DU determines whether the (first) UE Context Request message includes PDU Set QoS parameters (e.g,, for the (first) PDU session or the (first) QoS flow) for the (first) UE. If the DU determines that the (first) UE Context Request message includes PDU Set QoS parameters (e.g., for the PDU session or the QoS flow) for the (first) UE at block 704, the flow proceeds to block 722. At block 722, the DU enables PDU-Set-based QoS handling for data (e.g., associated with the (first) PDU session or the (first) QoS flow) for the (first) UE (e.g., event 322). Otherwise, if the DU determines that the (first) UE Context Request message does not include PDU Set QoS parameters (e.g., for the PDU session or the QoS flow) for the (first) UE at block 704, the flow proceeds to block 732. At block 732, the DU refrains from or disables PDU-Set-based QoS handling data (e.g., associated with the (first) PDU session or the (first) QoS flow) for the (first) UE.

In some implementations, the DU receives a second UE Context Request message (e.g., for a second PDU session or a second QoS flow) for a second UE from the CU (e.g., event 313). The DU transmits a second UE Context Response message to the CU in response to the second UE Context Request message (e.g., event 314). The DU determines whether the second UE Context Request message includes PDU Set QoS parameters (e.g., for the second PDU session or the second QoS flow) for the second UE. If the DU determines that the second UE Context Request message includes PDU Set QoS parameters (e.g., for the second PDU session or the second QoS flow) for the second UE, the DU enables PDU-Set-based QoS handling for data (e.g., associated with the second PDU session or the second QoS flow) for the second UE (e.g., event 322). Otherwise, if the DU determines that the second UE Context Request message does not include PDU Set QoS parameters (e.g., for the second PDU session or the second QoS flow) for the second UE, the DU refrains from or disables PDU-Set-based QoS handling data (e.g., associated with the second PDU session or the second QoS flow) for the second UE.

FIG. 7B is a flow diagram of an example method 700B similar to the method 700A, except that the method 700B includes block 705 instead of block 704. At block 705, the DU determines whether the UE Context Request message includes PDU Set QoS parameters (e.g., for the (first) PDU session or the (first) QoS flow), and whether the UE and/or DU support(s) PDU Set handling. If the DU determines that the UE Context Request message includes PDU Set QoS parameters (e.g., for the PDU session or the QoS flow) and the UE and/or DU support(s) PDU-Set-based handling at block 705, the flow proceeds to block 722. Otherwise, if the DU determines that the UE Context Request message does not include PDU Set QoS parameters and/or the UE and/or DU do/does not support PDU-Set-based QoS handling at block 705, the flow proceeds to block 732.

In some implementations, the DU receives a second UE Context Request message (e.g., for a second PDU session or a second QoS flow) for a second UE from the CU (e.g., event 313). The DU transmits a second UE Context Response message to the CU in response to the second UE Context Request message (e.g., event 314). The DU determines whether the second UE Context Request message includes PDU Set QoS parameters (e.g., for the second PDU session or the second QoS flow) for the second UE and the second UE and/or the DU support(s) PDU-Set-based QoS handling. If the DU determines that the second UE Context Request message includes PDU Set QoS parameters (e.g., for the second PDU session or the second QoS flow) for the second UE and the second UE and/or the DU support(s) PDU-Set-based QoS handling, the DU enables PDU-Set-based QoS handling for data (e.g., associated with the second PDU session or the second QoS flow) for the second UE (e.g., event 322). Otherwise, if the DU determines that the second UE Context Request message does not include PDU Set QoS parameters (e.g., for the second PDU session or the second QoS flow) for the second UE and/or the second UE and/or the DU do/does not support PDU-Set-based QoS handling, the DU refrains from or disables PDU-Set-based QoS handling data (e.g., associated with the second PDU session or the second QoS flow) for the second UE.

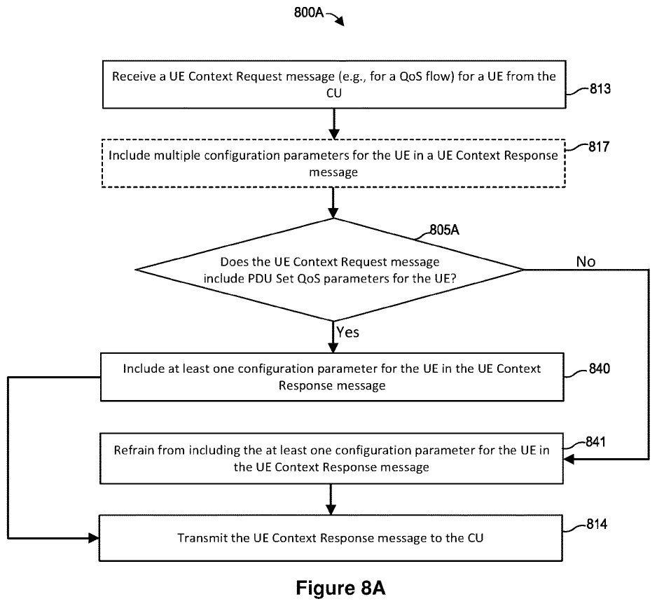

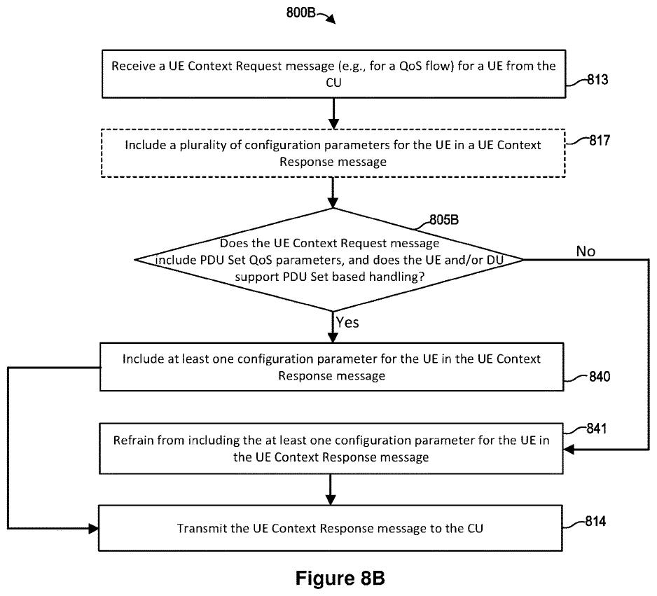

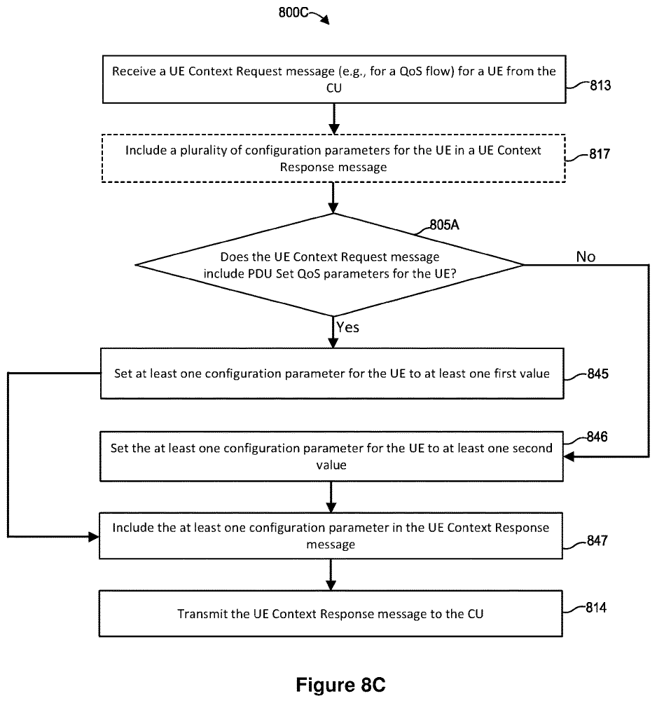

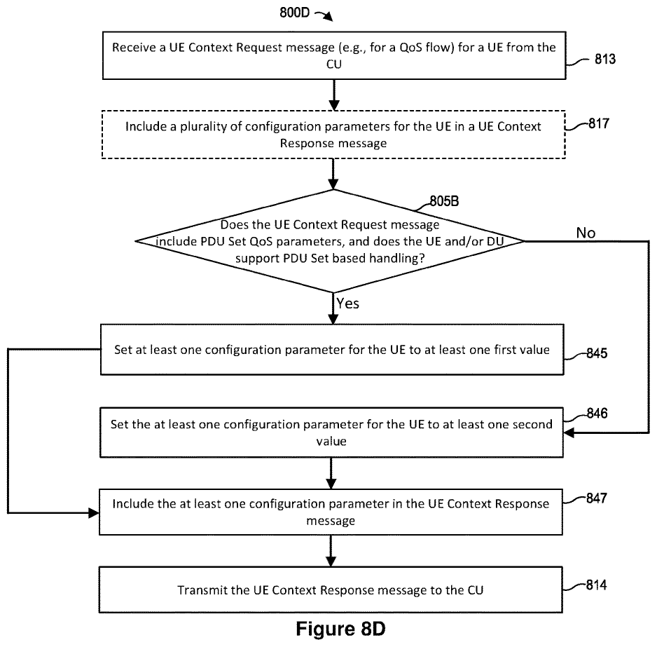

FIG. 8A is a flow diagram of an example method 800A for determining whether to configure one or more configuration parameters for PDU-Set-based QoS handling for a UE (e.g., the UE 102), which can be implemented by a DU (e.g., the DU 174 of the base station 104).

The method 800A begins at block 813, where the DU receives a UE Context Request message (e.g., for a PDU session or a QoS flow) for a UE from the CU (e.g., event 313). At block 817, the DU includes a plurality of configuration parameters for the UE in a UE Context Response message. At block 805A, the DU determines whether the UE Context Request message includes PDU Set QoS parameters (e. g,, for the PDU session or the QoS flow) for the UE. If the DU determines that the UE Context Request message includes PDU Set QoS parameters (e.g., for the PDU session or the QoS flow) for the UE at block 805A, the flow proceeds to block 840. At block 840, the DU includes at least one configuration parameter for the UE in the UE Context Response message. Otherwise, if the DU determines that the UE Context Request message does not include PDU Set QoS parameters (e.g., for the PDU session or the QoS flow) for the UE at block 805A, the flow proceeds to block 841. At block 841, the DU refrains from including the at least one configuration parameter in the UE Context Response message. The flow proceeds from block 840 to block 814. At block 814, the DU transmits the UE Context response message to the CU in response to the UE Context Request message (e.g., event 314).

In some implementations, after receiving the plurality of configuration parameters and/or the at least one configuration parameter from the DU, the CU transmits a RRC message including the plurality of configuration parameters and/or the at least one configuration parameter to the UE via the DU (e.g., event 316).

FIG. 8B is a flow diagram of an example method 800B similar to the method 800A, except that the method 800B includes block 805B instead of block 805A. At block 805B, the DU determines whether the UE Context Request message includes PDU Set QoS parameters (e. g,, for the PDU session or the QoS flow) for the UE, and/or whether the UE and/or DU support(s) PDU-Set-based QoS handling. If the DU determines that the UE Context Request message includes PDU Set QoS parameters (e.g., for the PDU session or the QoS flow) for the UE, and the UE and/or DU support(s) PDU-Set-based QoS handling at block 805B, the flow proceeds to block 840. Otherwise, if the DU determines that the UE Context Request message does not include PDU Set QoS parameters (e.g., for the PDU session or the QoS flow) for the UE and/or the UE and/or DU do/does not support PDU-Set-based QoS handling at block 805B, the flow proceeds to block 841.

FIG. 8C is a flow diagram of an example method 800C similar to the method 800A, except that the method 800C includes blocks 845 and 846 instead of blocks 808 and 810. If the DU determines that the UE Context Request message includes PDU Set QoS parameters (e.g., for the PDU session or the QoS flow) for the UE at block 805A, the flow proceeds to block 845. At block 845, the DU sets at least one configuration parameter for the UE to at least one first value. Otherwise, if the DU determines that the UE Context Request message does not include PDU Set QoS parameters (e.g., for the PDU session or the QoS flow) for the UE at block 805A, the flow proceeds to block 846. At block 846, the DU sets the at least one configuration parameter for the UE to at least one second value. The flow proceeds from block 807 to block 847, where the DU includes the at least one configuration parameter in the UE Context Response message.

FIG. 8D is a flow diagram of an example method 800D that includes certain steps of the methods 800A-800C.

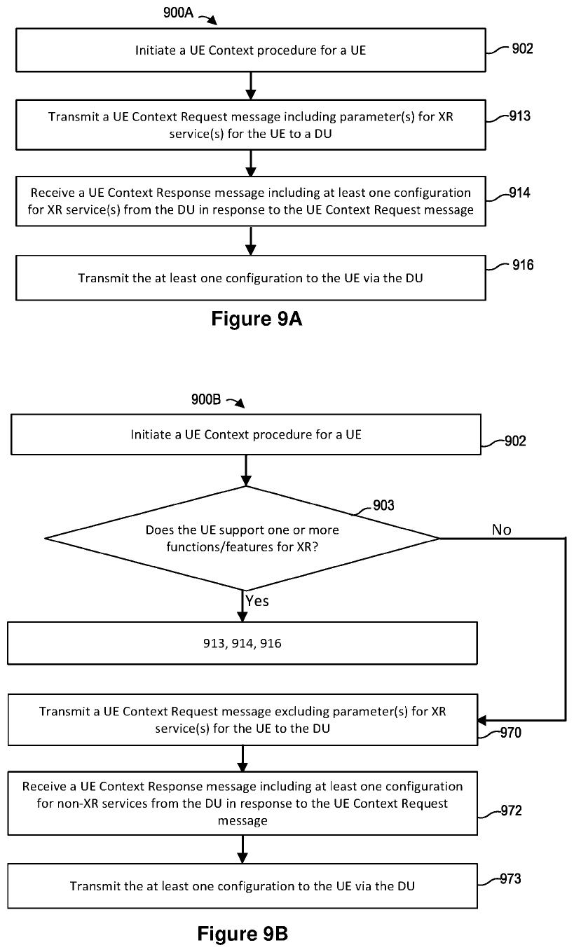

FIG. 9A is a flow diagram of an example method 900A for generating configuration parameters for a XR services and transmitting the configuration parameters to a UE (e.g., the UE 102) performing the XR service, which can be implemented by a CU (e.g., the CU 172 of the base station 104).

The method 900A begins at block 902, where the CU initiates a (first) UE Context procedure for a (first) UE (e.g., events 313, 314). At block 913, the CU transmits a (first) UE Context Request message including one or more parameters for one or more XR services for the (first) UE to a (first) DU (e.g., event 313). At block 914, the CU receives a (first) UE Context Response message including at least one (first) configuration for XR service(s) from the (first) DU in response to the (first) UE Context Request message (e.g., event 314). At block 916, the CU transmits the at least one (first) configuration to the (first) UE via the (first) DU (e.g., event 316).

In some implementations, the CU initiates a second UE Context procedure for a second UE (e.g., events 313, 314). In response to the initiation, the CU transmits a second UE Context Request message including one or more parameters for non-XR services for the second UE to a second DU (e.g., event 313). The CU receives second UE Context Response message including at least one second configuration for XR service(s) from the second DU in response to the second UE Context Request message (e.g., event 314). The CU transmits the at least one second configuration to the second UE via the second DU (e.g., event 316).

In some implementations, the first UE and second UE are the same UE. In other implementations, the first UE and second UE are different UEs. In some implementations, the first DU and second DU are the same DU. In other implementations, the first DU and second DU are different DUs. In some implementations, the first UE and second UE are the same UE. In other implementations, the first UE and second UE are different UEs. In some implementations, the first UE Context Request message and second UE Context Request message are the same UE Context Request message, and the first UE Context Response message and second UE Context Response message are the same UE Context Response message. In other implementations, the first UE Context Request message and second UE Context Request message are different UE Context Request messages, and the first UE Context Response message and second UE Context Response message are different UE Context Response messages.

FIG. 9B is a flow diagram of an example method 900B similar to the method 900A, except that the method 900B includes blocks 903, 905, 907 and 909. At block 903, the CU determines whether the UE supports one or more functions/features for XR. If the CU determines that the UE supports the one or more functions/features for XR at block 903, the flow proceeds to blocks 913, 914, and 916. Otherwise, if the CU determines that the UE does not support the one or more functions/features for XR at block 903, the flow proceeds to block 970. At block 970, the CU transmits a UE Context Request message excluding (the) one or more parameters for XR service(s) for the UE to the DU. At block 972, the CU receives a UE Context Response message including at least one configuration for non-XR services from the DU in response to the UE Context Request message. At block 916, the CU transmits the at least one configuration to the UE.

In some implementations, the one or more functions/features include multiple CG PUSCH transmission occasions in a period of a single CG PUSCH configuration, dynamic indication of unused CG PUSCH occasion(s) based on UCI by the UE, BSR enhancements including at least new buffer status table(s), delay reporting of buffered data in uplink, provision of XR traffic assistance information for DL and UL (e.g. periodicity) and/or PDU-Set-based QoS handling (e.g., discard operation of PDU Set(s)).

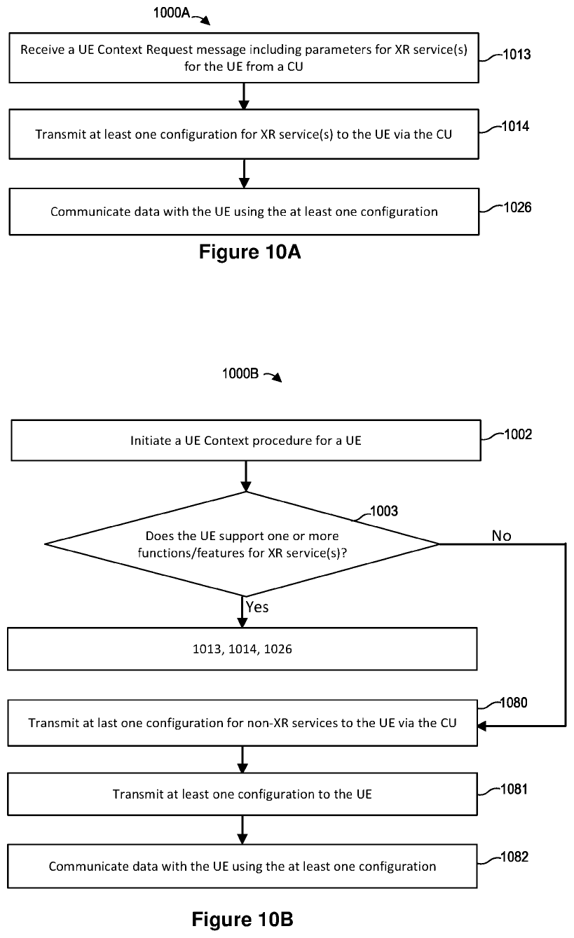

FIG. 10A is a flow diagram of an example method 1000A for one or more configuration parameters for XR services for a UE (e.g., the UE 102), which can be implemented by a DU (e.g., the DU 174 of the base station 104).

The method 1000A begins at block 1013, where the DU receives a (first) UE Context Request message including parameters for XR for a (first) UE from a CU (e.g., event 313). At block 1014, the DU transmits at least one (first) configuration for one or more XR service to the (first) UE via the CU (e.g., events 314, 316). At block 1026, the DU communicates data with the (first) UE using the at least one (first) configuration (e.g., event 326).

In some implementations, the DU receives a second UE Context Request message including parameter(s) for non-XR services for a second UE from the CU (e.g., event 313). The DU transmits at least one second configuration for non-XR service(s) to the second UE via the CU (e.g., events 314, 316). The DU communicates data with the second UE using the at least one second configuration (e.g., event 326). In some implementations, the first UE and second UE are the same UE. In other implementations, the first UE and second UE are different UEs. In some implementations, the first UE and second UE are the same UE. In other implementations, the first UE and second UE are different UEs. In some implementations, the first UE Context Request message and second UE Context Request message are the same UE Context Request message, and the first UE Context Response message and second UE Context Response message are the same UE Context Response message. In other implementations, the first UE Context Request message and second UE Context Request message are different UE Context Request messages, and the first UE Context Response message and second UE Context Response message are different UE Context Response messages.

FIG. 10B is a flow diagram of an example method 1000B similar to the method 1000A, except that the method 1000B includes blocks 1008, 1080, 1081 and 1082. At block 1008, the DU determines whether the UE supports one or more functions/features for one or more XR services. If the DU determines that the UE supports one or more functions/features for XR service(s), the flow proceeds to block 1013, 1014, and 1026. Otherwise, if the DU determines that the UE does not support (the) one or more functions/features for XR service(s), the flow proceeds to block 1080. At block 1080, the DU transmits at least one configuration for non-XR services to the UE via the CU. At block 1081, the DU transmits the at least one configuration to the UE. At block 1082, the DU communicates data with the UE using the at least one configuration.

The following additional considerations apply to the foregoing discussion.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “at least one” means “one or more”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

When implemented in software, the techniques can be provided as part of the operating system, a library used by multiple applications, a particular software application, etc. The software can be executed by one or more general-purpose processors or one or more special-purpose processors.

1. A method implemented in a centralized unit (CU) of a distributed base station that also includes a distributed unit (DU), the method comprising:
transmitting, to the DU, a request related to a context of a UE that communicates with a core network (CN) via the DU and the CU, the request including a packet data unit (PDU) Set quality of service (QoS) parameter for a QoS flow;
receiving, from the DU, a response to the request; and
communicating, between the CN and the UE via the DU, a data packet in the QoS flow.

2. The method of claim 1, wherein the PDU Set QoS parameter includes at least one of:
(i) a PDU Set Delay Budget (PSDB),
(ii) a PDU Set Error Rate (PSER),
(iii) a PDU Set Integrated Handling Information (PSIHI).

3. The method of claim 1, wherein:
the PDU Set QoS parameter is an uplink (UL) PDU Set QoS parameter.

4. The method of claim 1, wherein:
the PDU Set QoS parameter is a downlink (DL) PDU Set QoS parameter.

5. The method of claim 1, wherein:
the request includes a UE Context Setup Request message.

6. The method of claim 1, wherein:
the request includes a UE Context Modification Request message.

7. The method of claim 1, further comprising:
configuring the UE with a data radio bearer (DRB) associated with the QoS flow.

8. The method of claim 1, wherein:
the response to the request includes a confirmation that the DU supports PDU-Set-based QoS handling.

9. The method of claim 1, wherein:
the transmitting of the request including the PDU Set QoS parameter is in response to receiving an indication that the UE supports PDU-Set-based QoS handling.

10. The method of claim 1, wherein:
the PDU Set QoS parameter pertains to a PDU set that includes a plurality of PDUs carrying a payload of a unit of information generated an application level.

11. The method of claim 1, further comprising:
receiving, from the CN, a request to allocate resources for a PDU session including the QoS flow, the requesting including the PDU Set QoS parameter.

12. A method implemented in a distributed unit (DU) of a distributed base station that also includes a centralized unit (CU), the method comprising:
receiving, from the CU, a request related to a context of a UE that communicates with a core network (CN) via the DU and the CU, the request including a packet data unit (PDU) Set quality of service (QoS) parameter for a QoS flow;
transmitting, from the CU, a response to the request; and
communicating, between the CN and the UE via the CU, a data packet in the QoS flow in accordance with the PDU Set QoS parameter.

13. The method of claim 12, further comprising:
determining that the DU supports PDU-Set-based QoS handling.

14. The method of claim 12, wherein:
the request includes one of a UE Context Setup Request message or a UE Context Modification Request message.

15. A centralized unit (CU) of a distributed base station that also includes a distributed unit (DU), the CU comprising processing hardware and configured to:
transmit, to the DU, a request related to a context of a UE that communicates with a core network (CN) via the DU and the CU, the request including a packet data unit (PDU) Set quality of service (QoS) parameter for a QoS flow;
receive, from the DU, a response to the request; and
communicate, between the CN and the UE via the DU, a data packet in the QoS flow.

16. The CU of claim 15, wherein:
the request includes a UE Context Setup Request message.

17. The CU of claim 15, wherein:
the request includes a UE Context Modification Request message.

18. The CU of claim 15, further configured to:
configure the UE with a data radio bearer (DRB) associated with the QoS flow.

19. The CU of claim 15, wherein:
the response to the request includes a confirmation that the DU supports PDU-Set-based QoS handling.

20. The CU of claim 15, wherein:
the transmitting of the request including the PDU Set QoS parameter is in response to receiving an indication that the UE supports PDU-Set-based QoS handling.
